(19) United States
(12) Patent Application Publication
(10) Pub. No.: US 2009/0184685 A1
(43) Pub. Date: Jul. 23, 2009

(54) BATTERY PACK AND METHOD OF CHARGING THE SAME

(75) Inventors: Se-Sub SIM, Suwon-si (KR); Susumu Segawa, Suwon-si (KR); Jong-Woon Yang, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/358,623

(22) Filed: Jan. 23, 2009

(30) Foreign Application Priority Data
Jan. 23, 2008 (KR) 2008-7161

(51) Int. Cl. H02J 7/00; H02J 7/04

(52) U.S. Cl. 320/134; 320/162

(57) ABSTRACT

A method of charging a battery pack including at least one secondary battery includes charging the secondary battery using a constant current-constant voltage method, measuring a charging voltage applied to the secondary battery, interrupting the charging the secondary battery when the charging voltage of the secondary battery is equal to or higher than a first set voltage, measuring an open circuit voltage (OCV) of the battery pack in during or after a second time period after the charging has been interrupted, and terminating the charging of the battery pack when the measured OCV is equal to or higher than a second set voltage.

### CROSS-REFERENCE TO RELATED APPLICATION

This application claims the benefit of Korean Patent Application No. 2008-7161, filed Jan. 23, 2008 in the Korean Intellectual Property Office, the disclosure of which is incorporated herein by reference.

### BACKGROUND OF THE INVENTION

1. Field of the Invention

Aspects of the present invention relate to a battery pack and a method of charging the same, and more particularly, to a battery pack in which decreases in stability and life span can be prevented by changing a standard for determining a charge completion time of the battery pack to prevent overcharge of the battery pack, and a method of charging the same.

2. Description of the Related Art

Recently, compact and lightweight hand-held electrical/electronic appliances such as cellular phones, notebook computers, and camcorders have been vigorously developed and manufactured. These appliances typically employ a battery pack so that they can operate anywhere without the application of a separate power source. The battery pack generally uses a nickel-cadmium (Ni—Cd) battery, a nickel-metal hydride (Ni-MH) battery or a lithium (Li) battery, which is a rechargeable secondary battery in consideration of the economic aspect.

Since the Li secondary battery has a higher operating voltage (i.e., about three times higher), and a higher energy density per unit weight than the Ni—Cd or Ni-MH battery, the battery pack using the Li secondary battery is widely used in hand-held electrical/electronic appliances. A Li secondary battery can be classified into a Li ion battery using a liquid electrolyte and a lithium polymer battery using a polymer electrolyte according to the kind of the electrolyte, or classified into a cylindrical type, a prismatic type and a pouch type according to the shape of the battery.

When the Li secondary battery is used in the battery pack, the Li secondary battery is electrically connected to a protection circuit board to prevent overcharge of the Li secondary battery during charging/discharging, or may be formed as a bare cell type to be electrically connected to the protection circuit board.

Generally, the battery pack using the Li secondary battery may be charged using a constant current-constant voltage (CC/CV) method, which reduces a current applied to the battery pack by setting a constant voltage as a charging voltage, applying a constant current to the battery pack until a voltage of the battery pack reaches the set charging voltage, and maintaining the voltage applied to the battery pack to the charging voltage after the voltage of the battery pack reaches the set charging voltage.

In the CC/CV charging method, a section in which a constant current is applied to the battery pack is referred to as a constant current section (CC section), and a section in which a constant voltage is applied thereto is referred to as a constant voltage section (CV section). Further, when the current applied to the battery pack is reduced to C/20 in the CV section, it is determined that the battery pack is fully charged, and the charging is terminated. Here, 1 C means that the battery is charged with the same current as the rating capacity of the Li secondary battery. For example, when the capacity of the Li secondary battery is 1000 mAh and a current amount applied for charging is 1000 mAh, it is defined as 1 C charge, and when the applied current amount is 2000 mAh, it is defined as 2 C charge. In this example, a C/20 charge would be 50 mAh.

The battery pack is fully charged before the charging current reaches C/20 in the CV section, when the charging voltage applied for charging the battery pack is the maximum permissible charging voltage. Thus, when the charge completion time of the battery pack is determined by the conventional method, the battery pack may be overcharged, and thus stability and life span of the battery pack may be reduced.

### SUMMARY OF THE INVENTION

Aspects of the present invention provide a battery pack that can prevent overcharge regardless of a charging voltage applied to the battery pack by determining a charge completion time of the battery pack using an open circuit voltage (OCV) of the battery pack, and a method of charging the same.

According to an embodiment of the present invention, there is provided a method of charging a battery pack including at least one secondary battery, comprising: charging the secondary battery using a constant current-constant voltage method; measuring a charging voltage applied to the secondary battery; when the charging voltage of the secondary battery is equal to or higher than a first set voltage, maintaining the charging voltage at the first set voltage for a first set time period and interrupting the charging of the secondary battery after the end of the first set time period; measuring an open circuit voltage (OCV) of the battery pack after the charging has been interrupted for a second set period of time; and terminating the charging of the battery pack when the measured OCV is equal to or higher than a second set voltage.

According to another embodiment of the present invention, there is provided a method of charging a battery pack including at least one bare cell and a battery management system controlling charging/discharging of the bare cell, comprising: measuring a charging voltage applied to the bare cell through the battery management system; interrupting a charging of the battery pack after a first set time period when the measured charging voltage is equal to or higher than a first set voltage; measuring an OCV of the battery pack during or after a second set time period after the charging is interrupted; and terminating the charging of the battery pack when the OCV of the battery pack is equal to or higher than a second set voltage.

According to another embodiment of the present invention, there is provided a method of charging a battery pack that includes at least one secondary battery, comprising: commencing charging of the secondary battery by a constant current-constant voltage method while measuring a charging voltage applied to the secondary battery; when an applied charging voltage of the secondary battery reaches a first set voltage, maintaining the charging voltage at the applied first set voltage for a first set time period; interrupting the charging of the secondary battery after the first set time period; measuring an open circuit voltage (OCV) of the battery pack during or after a second set time period after the interrupting of the charging; comparing the measured OCV with a second set voltage; if the measured OCV is less than a second set voltage, repeating the maintaining of the charging voltage at the applied first set voltage for the first set time period, the interrupting of the charging of the secondary battery after the first set time period, the measuring of the open circuit voltage (OCV) of the battery pack during or after the second set time period and the comparing of the measured OCV with the second set voltage; and if the measured OCV is equal to or higher than the second set voltage, terminating the charging of the battery pack.

According to another embodiment of the present invention, there is provided a battery pack comprising: a battery assembly including at least one unit battery; and a battery management system that controls charging/discharging of the battery assembly and controls the charging of the battery assembly according to an OCV of the battery assembly.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view of a battery pack according to an embodiment of the present invention;

FIG. 2 is a waveform of a charging voltage applied to the battery pack of FIG. 1; and

FIG. 3 is a flowchart illustrating a method of charging a battery pack according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

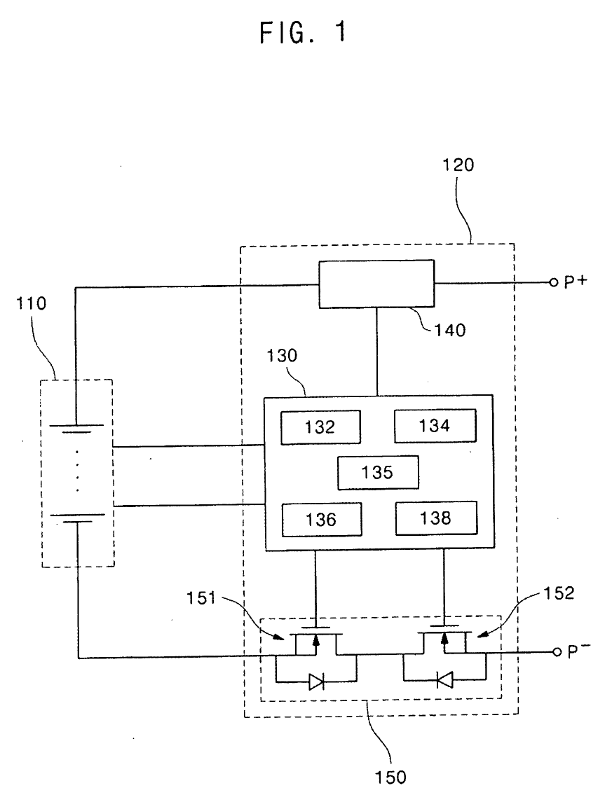

FIG. 1 is a schematic view of a battery pack according to an embodiment of the present invention. Referring to FIG. 1, the battery pack includes a battery assembly 110 including at least one bare cell or a secondary battery which is rechargeable, a battery management system 120 and external terminals P+ and P− electrically connecting the battery assembly 110 with an external power supply or load.

The battery management system 120 includes a controller 130 that controls charging/discharging of the battery assembly, and a charge/discharge controller 150 that controls an electrical connection between the battery assembly 110 and the external terminals P+ and P− in response to a signal from the controller 130.

The battery management system 120 may further include secondary protection devices 140 such as a fuse disposed on a high current path of the battery assembly 110 and blocking the electrical connection between the battery assembly 110 and the external terminals P+ and P−, a self-control protector (SCP) or a positive temperature coefficient (PTC) thermistor, in order to prevent the flow of overcurrent through the battery assembly 110 due to a malfunction of the controller 130 or the charge/discharge controller 150.

The controller 130 includes a voltage measuring part 132 that measures a charging voltage of the battery assembly 110, an open circuit voltage (OCV) measuring part 134 that measures an OCV of the battery assembly 110, a voltage comparing part 136 that compares the charging voltage and the OCV with a set voltage of the battery assembly 110, a full-charge/discharge detecting part 138 that determines whether or not the battery assembly is fully charged in response to a signal received from the voltage comparing part 136, and a protection circuit 135 that controls the charging/discharging of the battery assembly 110 according to a charged state of the battery assembly 110. The voltage comparing part 136 may include a first voltage comparing part (not separately illustrated) that compares the charging voltage of the battery assembly 110 with a first set voltage, and a second voltage comparing part (not illustrated) that compares the OCV of the battery assembly 110 with a second set voltage.

The charge/discharge controller 150 includes a charge FET device 151 and a discharge FET device 152, and controls the charging/discharging of the battery assembly 110 by driving any one of the charge and discharge FET devices 151 and 152 by the control of the protection circuit 135 and the full-charge detecting part 138.

The external terminals P+ and P− are connected parallel to the battery assembly 110, and comprise a positive electrode (P+) and a negative electrode (P−). The external terminals P+ and P− may electrically connect the electrode assembly 110 to the external power supply or load so as to charge or discharge the battery assembly 110. More specifically, when the external power supply is connected to the external terminals P+ and P−, the battery assembly 110 is charged, and when the load is connected to the external terminals P+ and P−, the battery assembly 110 is discharged.

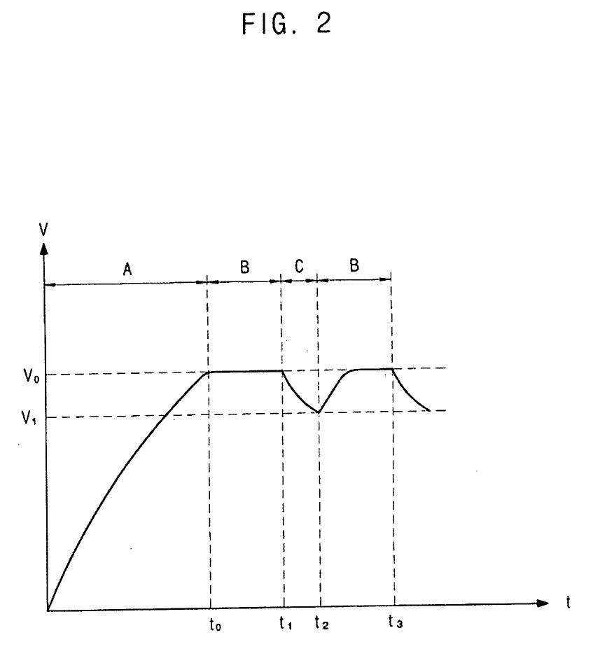

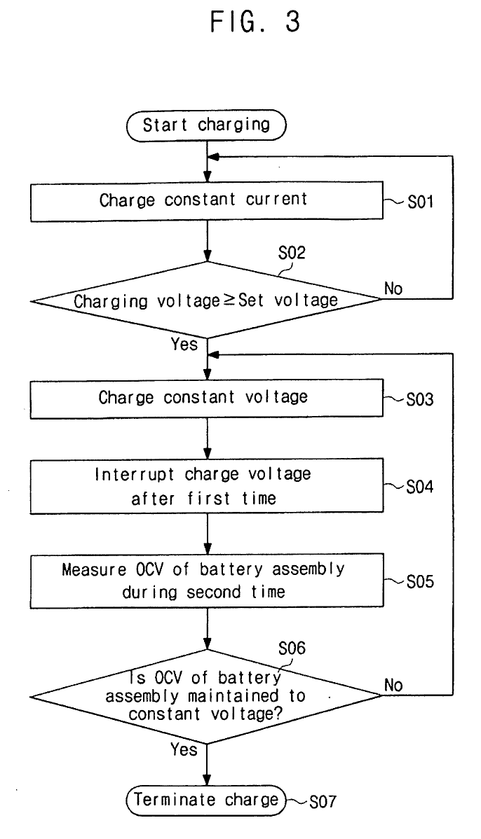

FIG. 2 is a waveform of a charging voltage applied to the battery pack of FIG. 1, and FIG. 3 is a flowchart illustrating a method of charging a battery pack according to an embodiment of the present invention. In the method of charging a battery pack, when an external power supply is connected to external terminals P+ and P−, and the battery pack starts to charge, the method resembles a conventional constant current-constant voltage (CC/CV) method in that the battery pack gradually increases a charging voltage applied to the battery assembly 110 to flow a constant current into the battery assembly 110, in a constant current section (indicated by reference character “A” in FIG. 2), in which the charging voltage applied to the battery assembly 110 reaches a first set voltage V0, (S01). Here, the first set voltage V0 may be a charging voltage such as may be used in a constant voltage section in the conventional CC/CV method.

Subsequently, when the voltage applied to the battery assembly 110 is equal to or higher than the first set voltage V0 (S02), the charging voltage applied to the battery assembly 110 is maintained at a voltage corresponding to the first set voltage V0 (S03) for a first set time period (t1-t0), as in the constant voltage section of the CC/CV method. The constant voltage section is indicated by reference character “B” in FIG. 2.

After the constant voltage section B, the charging voltage applied to the battery assembly 110 is interrupted (S04).

As a non-limiting example, a first set time period, that is, the time period (t1-t0) of the constant voltage section B, may be 1 to 2 minutes. When the time period of the constant voltage section B is too long, the same problems that occur in the conventional charging method may occur. That is, there may be overcharging of the battery assembly 110. On the other hand, when the time period of the constant voltage section B is too short, the overall time taken to charge the battery pack increases. Alternatively, the charging voltage applied to the battery assembly 110 may be interrupted right after the charging voltage applied to the battery assembly 110 reaches the first set voltage V0 without maintaining the voltage at V0 for the first set time period.

Then, during a second set time period, which is a charge stop section indicated by reference character “C” in FIG. 2 and in which the charging voltage is interrupted, the open circuit voltage (OCV) of the battery assembly 110 is measured (S05). Alternatively, the OCV of the battery assembly 110 may be measured after expiration of the second set time period, that is, the time period (t2-t1) of the charge stop section C.

The second set time period (t2-t1) of the charge stop section C may be shorter than the first set time period (t1-t0) of the constant voltage section B. When the time period of the charge stop section C is too long, the voltage of the battery assembly 110 may significantly decrease, and when the time period of the charge stop section C is too short, the OCV of the battery assembly 110 may not be stably measured. As a non-limiting example, the second set time period may be 5 to 10 seconds.

Then, whether the OCV of the battery assembly 110 is equal to or higher than a second set voltage is determined (S06). If the OCV is equal to or higher than the second set voltage, the charging of the battery assembly 110 is completed (S07). If the OCV of the battery assembly 110 is determined to be less than the second set voltage, a voltage corresponding to the first set voltage V0 is once again applied to the battery assembly 110 to charge the battery assembly 110 with a constant voltage for the first set time period (returning to S03). Here, since the first set voltage V0 is applied as the charging voltage to charge the battery assembly 110, even after the voltage of the battery assembly 110 decreases to a lower level V1 during to the charge stop section C, the charging voltage of the battery assembly 110 never exceeds the first set voltage V0.

Accordingly, as long as the voltage assembly 110 is determined to have an OCV less than the second set voltage during or at the end of the second set time period, the charging of the battery assembly 110 in the constant voltage section B with the voltage corresponding to the first set voltage V0, the interrupting of the charging in the charge stop section C, the measuring of the OCV and the comparing of the OCV of the battery assembly 110 with the second set voltage are repeatedly performed.

Consequently, the battery pack according to the embodiment of the present invention determines the charge stop time by interrupting charging after a first set time period of charging at a constant voltage, measuring an OCV of the battery pack during or after a second set time period after the charging is interrupted and comparing the OCV with a first set voltage, so as to prevent overcharge of the battery pack even when the maximum permissible charging voltage is applied for charging the battery pack and thus to prevent decreases in stability and life span of the battery pack.

Although aspects of the present invention have been described with reference to certain exemplary embodiments thereof, it is to be understood by those skilled in the art that a variety of modifications and variations may be made to the present invention without departing from the spirit or scope of the present invention defined in the appended claims, and their equivalents. Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of charging a battery pack including at least one secondary battery, comprising:
charging the secondary battery using a constant current-constant voltage method;
measuring a charging voltage applied to the secondary battery;
interrupting the charging of the secondary battery when the charging voltage of the secondary battery is equal to or higher than a first set voltage;
measuring an open circuit voltage (OCV) of the battery pack after the charging has been interrupted; and
terminating the charging of the battery pack when the measured OCV is equal to or higher than a second set voltage.

2. The method according to claim 1, wherein when the charging voltage applied to the secondary battery is equal to or higher than the first set voltage, the charging of the secondary battery is maintained for a first set time period applying the first set voltage before the charging of the secondary battery is interrupted, and the measuring of the OCV of the secondary battery is carried out during or after a second set time period after the charging of the secondary battery is interrupted.

3. The method according to claim 2, wherein the second set time period is shorter than the first set time period.

4. The method according to claim 2, wherein the first set time period is 1 to 2 minutes.

5. The method according to claim 1, wherein when the measured OCV is less than the second set voltage, the charging of the secondary battery is resumed by applying the first set voltage as a charging voltage.

6. The method of claim 2, wherein when the measured OCV is less than the second set voltage, the maintaining of the charging of the secondary battery for the first set time period, the interrupting of the charging of the secondary battery and the measuring of the OCV of the secondary battery during or after a second set period of time after the charging of the battery is interrupted are repeated until the measured OCV is equal to or higher than the second set voltage.

7. The method according to claim 1, wherein the second set time period is 5 to 10 seconds.

8. The method according to claim 1, wherein the first set voltage is a charging voltage that is converted into a constant voltage section from a constant current section in the constant current-constant voltage method.

9. The method according to claim 1, wherein the OCV of the secondary battery is measured during the second set time period.

10. A method of charging a battery pack including at least one bare cell and a battery management system controlling charging/discharging of the bare cell, comprising:
measuring a charging voltage applied to the bare cell through the battery management system;
interrupting a charging of the battery pack after a first set time period when the measured charging voltage is equal to or higher than a first set voltage;
measuring an OCV of the battery pack during or after a second set time period after the charging is interrupted; and
terminating the charging of the battery pack when the OCV of the battery pack is equal to or higher than a second set voltage.

11. The method according to claim 9, wherein the charging voltage is applied using a constant current-constant voltage method.

12. The method according to claim 11, wherein the first set voltage is a voltage that is converted into a constant voltage section from a constant current section.

13. The method according to claim 10, wherein the first set time period is longer than the second set time period.

14. The method according to claim 13, wherein the first set time period is 1 to 2 minutes.

15. The method according to claim 13, wherein the second set time period is 5 to 10 seconds.

16. The method according to claim 10, wherein the OCV of the battery pack is measured during the second set time period.

17. A battery pack comprising:
a battery assembly including at least one unit battery; and
a battery management system that controls charging/discharging of the battery assembly and controls the charging of the battery assembly according to an OCV of the battery assembly.

18. The battery pack according to claim 17, wherein the battery management system includes:
a voltage measuring part that measures a charging voltage of the battery assembly;
an OCV measuring part that measures the OCV of the battery assembly;
a voltage comparing part that compares the charging voltage and the OCV of the battery assembly with a set voltage; and
a full-charge detecting part that determines whether or not the battery assembly is fully charged in response to a signal from the voltage comparing part.

19. The battery pack according to claim 18, wherein the voltage comparing part includes a first voltage comparing part that compares the charging voltage of the battery assembly with a fifth set voltage, and a second voltage comparing part that compares the OCV of the battery assembly with a sixth set voltage.

20. The battery pack according to claim 18, wherein the battery management system further includes a protection circuit that controls the charging/discharging of the battery assembly depending on a charged state of the battery assembly.

21. The battery pack according to claim 20, wherein the battery management system includes a charge/discharge controller electrically connected between the battery assembly and an external terminal to control an electrical connection between the battery assembly and the external terminal in response to signals from the full-charge detecting part and the protection circuit.

22. The battery pack according to claim 21, wherein the charge/discharge controller includes a charge FET device and a discharge FET device.

23. A method of charging a battery pack that includes at least one secondary battery, comprising:
commencing charging of the secondary battery by a constant current-constant voltage method while measuring a charging voltage applied to the secondary battery;
when the applied charging voltage of the secondary battery reaches a first set voltage, maintaining the charging voltage at the applied first set voltage for a first set time period;
interrupting the charging of the secondary battery after the first set time period;
measuring an open circuit voltage (OCV) of the battery pack during or after a second set time period after the interrupting of the charging;
comparing the measured OCV with a second set voltage;
if the measured OCV is less than a second set voltage, repeating the maintaining of the charging voltage at the applied first set voltage for the first set time period, the interrupting of the charging of the secondary battery after the first set time period, the measuring of the open circuit voltage (OCV) of the battery pack during or after the second set time period and the comparing of the measured OCV with the second set voltage; and
if the measured OCV is equal to or higher than the second set voltage, terminating the charging of the battery pack.

24. The method according to claim 23, wherein the first set time period is 1 to 2 minutes.

25. The method according to claim 23, wherein the second set time period is 5 to 10 seconds.
